(19) United States
(12) Patent Application Publication
(10) Pub. No.: US 2004/0192269 A1
(43) Pub. Date: Sep. 30, 2004

(54) System and method for assignment of context classifications to mobile stations

(76) Inventor: Thomas Casey Hill, Crystal Lake, IL (US)

Correspondence Address: MOTOROLA INC, 600 NORTH US HIGHWAY 45, ROOM AS437, LIBERTYVILLE, IL, 60048-5343, US

(21) Appl. No.: 10/397,725

(22) Filed: Mar. 26, 2003

(51) Int. Cl. H04M 3/42

(52) U.S. Cl. 455/414.1; 455/566; 455/456.1

(57) ABSTRACT

There is presented a mobile station (160, 162, 164, 166) in communication with a remote device (160, 162, 164, 166, 180) and a method of operating the same. The mobile station receives (410) context classifications associated with an application (214, 314) from the remote device. When the mobile station detects (420) an event, the mobile station determines (430), its current state and selects a particular classification based on its current state. The mobile station provides (450) the particular classification to the remote device for utilization by the application. The mobile station may also communicate (540) appropriate classifications to different applications.

### FIELD OF THE INVENTION

The present invention relates generally to the field of wireless communication systems, and more particularly, to a system and method for assigning context classifications to mobile stations.

### BACKGROUND OF THE INVENTION

Wireless communication systems are capable of communicating information about a mobile station to another entity. For certain operations, the entity that receives such information may make decisions based the information. For example, a mobile station and a server that concurrently operate the same application may share information and make decisions based on the shared information in order to synchronize their operations. By sharing information, each entity has more information to consider and, thus, may potentially make better decisions.

Wireless communication systems may share context information about a mobile station to another entity. For example, a server may receive location information (i.e., exact coordinates) about a mobile station, determine that the mobile station has entered or exited a particular area of interest and, in response, attempt to communicate with the mobile station. Unfortunately, each entity classifies information by its own predetermined categories. For the above example, the server may receive exact location coordinates generated by a Global Positioning System, but only desire to know the mobile station's position relative to the particular area of interest. Each entity that receives the information may be burdened by converting the information to its own classifications, particularly if the receiving entity processes information differently from the sending entity. Other entities that received the information may use different categories and require processing power to interpret, analyze, or convert the received information, assuming the receiving entity can interpret, analyze, or convert the received information at all.

Accordingly, there is a system, method, and mobile stations that correlate local information to predetermined categories of one or more remote entities.

### BRIEF DESCRIPTION OF THE DRAWINGS

FIG. 1 is a block diagram representing a wireless communication system including mobile stations communicating through a communication network.

FIG. 2 is a block diagram representing of one or more of the mobile stations of FIG. 1.

FIG. 3 is a block diagram representing a server within the communication network of FIG. 1.

FIG. 4 is a flow diagram representing a first preferred operation of the mobile station of FIG. 1.

FIG. 5 is a flow diagram representing a second preferred operation of the mobile station of FIG. 1

FIG. 6 is a flow diagram illustrating a third preferred operation of the mobile station of FIG. 1.

FIG. 7 is a table representing exemplary information that is correlated by the wireless communication system of FIG. 1.

FIG. 8 is another table representing exemplary information that is correlated by the wireless communication system of FIG. 1.

### DETAILED DESCRIPTION OF THE PREFERRED EMBODIMENTS

The present invention is a system, method, and mobile stations that correlate local information to predetermined categories of one or more remote entities. For one embodiment, a mobile station, and a method thereof, correlates a current state of the mobile state to a plurality of context classifications received from a remote device. For another embodiment, a method correlates a current classification to a plurality of predetermined classifications and communicates the appropriate classifications to two or more applications.

The present invention is a mobile station in communication with a remote device and a method of operating the mobile station. The mobile station comprises a transceiver, a sensor, and a processor coupled to the transceiver and the sensor. The transceiver is configured to receive a plurality of context classifications associated with an application from the remote device. The sensor is configured to detect an event of the mobile station. The processor is configured to determine a current state of the mobile station, in response to detecting the event, and select a particular classification of the plurality of context classifications based on the current state of the mobile station. The transceiver circuit provides the particular classification to the remote device for utilization by the application.

The present invention is also another method of operating the mobile station. The processor ascertains a current classification of a variable device characteristic based upon the event detected by the sensor. The processor correlates the current classification with a plurality of predefined classifications associated with the variable device characteristic. The transceiver communicates the respective appropriate classifications to different applications.

Although the embodiments disclosed herein are particularly well suited for use with a cellular telephone such as one operable in accordance with Java 2 platform, Micro Edition (“J2ME”), persons of ordinary skill in the art will readily appreciate that the teachings of this disclosure are in no way limited to cellular telephones. On the contrary, persons of ordinary skill in the art will readily appreciate that the teachings of this disclosure can be employed with any wireless communication device such as a pager and a personal digital assistant (“PDA”).

The wireless communication system in accordance with the present invention is described in terms of several preferred embodiments, and particularly, in terms of a wireless communication system operating in accordance with at least one of several standards. These standards include analog, digital or dual-mode communication system protocols such as, but not limited to, the Advanced Mobile Phone System (“AMPS”), the Narrowband Advanced Mobile Phone System (“NAMPS”), the Global System for Mobile Communications (“GSM”), the IS-55 Time Division Multiple Access (“TDMA”) digital cellular system, the IS-95 Code Division Multiple Access (“CDMA”) digital cellular system, CDMA 2000, the Personal Communications System (“PCS”), 3G, the Universal Mobile Telecommunications System (“UMTS”), and variations and evolutions of these protocols. The wireless communication system in accordance with the present invention may also operate via an ad hoc network and, thus, provide point-to-point communication with the need for intervening infrastructure. Examples of the communication protocols used by the ad hoc networks include, but are not limited to, IEEE 802.11a, IEEE 802.11b, IEEE 802.11g, Bluetooth, and infrared technologies.

The wireless communication system is a complex network of systems and elements. Typical systems and elements include (1) a radio link to mobile stations (e.g., a cellular telephone or a subscriber equipment used to access the wireless communication system), which is usually provided by at least one and typically several base stations, (2) communication links between the base stations, (3) a controller, typically one or more base station controllers or centralized base station controllers (“BSC/CBSC”), to control communication between and to manage the operation and interaction of the base stations, (4) a switching system, typically including a mobile switching center (“MSC”), to perform call processing within the system, and (5) a link to the land line, i.e., the public switch telephone network (“PSTN”) or the integrated services digital network (“ISDN”).

A base station subsystem (“BSS”) or a radio access network (“RAN”), which typically includes one or more base station controllers and a plurality of base stations, provides all of the radio-related functions. The base station controller provides all the control functions and physical links between the switching system and the base stations. The base station controller is also a high-capacity switch that provides functions such as handover, cell configuration, and control of radio frequency (RF) power levels in the base stations.

The base station handles the radio interface to the mobile station. The base station includes the radio equipment (transceivers, antennas, amplifiers, etc.) needed to service each communication cell in the system. A group of base stations is controlled by a base station controller. Thus, the base station controller operates in conjunction with the base station as part of the base station subsystem to provide the mobile station with real-time voice, data, and multimedia services (e.g., a call).

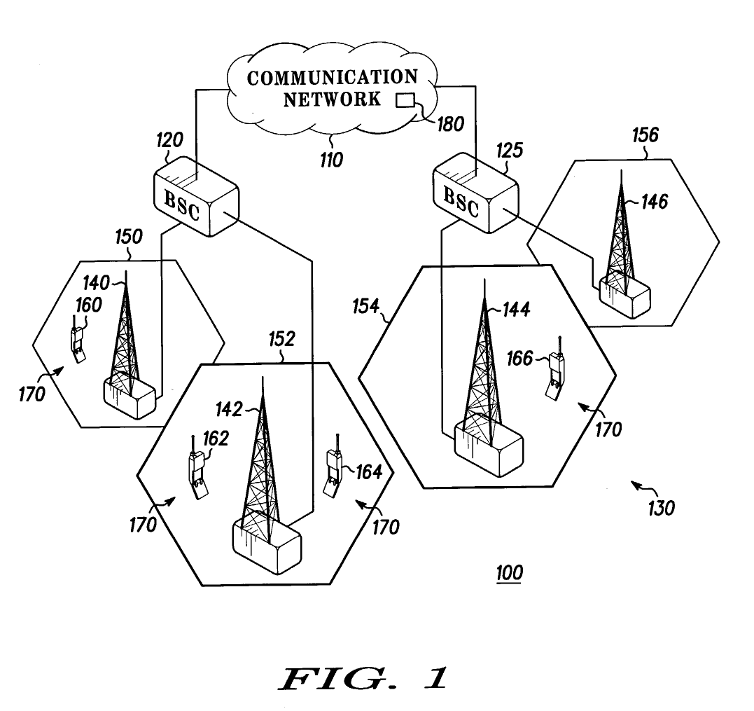

Referring to FIG. 1, a wireless communication system 100 includes a communication network 110 and a plurality of base station controllers (“BSC”), generally shown as 120 and 125, servicing a total service area 130. As is known for such systems, each BSC 120 and 125 has associated therewith a plurality of base stations (“BS”), generally shown as 140, 142, 144, and 146, servicing communication cells, generally shown as 150, 152, 154, and 156, within the total service area 130. The BSCs 120 and 125, and base stations 140, 142, 144, and 146 are specified and operate in accordance with the applicable standard or standards for providing wireless communication services to a plurality of mobile stations (“MS”) 170, generally shown as 160, 162, 164, and 166, operating in communication cells 150, 152, 154, and 156. In accordance with the present invention, the communication network may include, or communicate with, a server 180 that is capable of communicating with the mobile stations 170 via the BSCs 120 and 125, and the base stations 140, 142, 144, and 146. Each of the elements described above in reference to FIG. 1 are commercially available from Motorola, Inc. of Schaumburg, Ill.

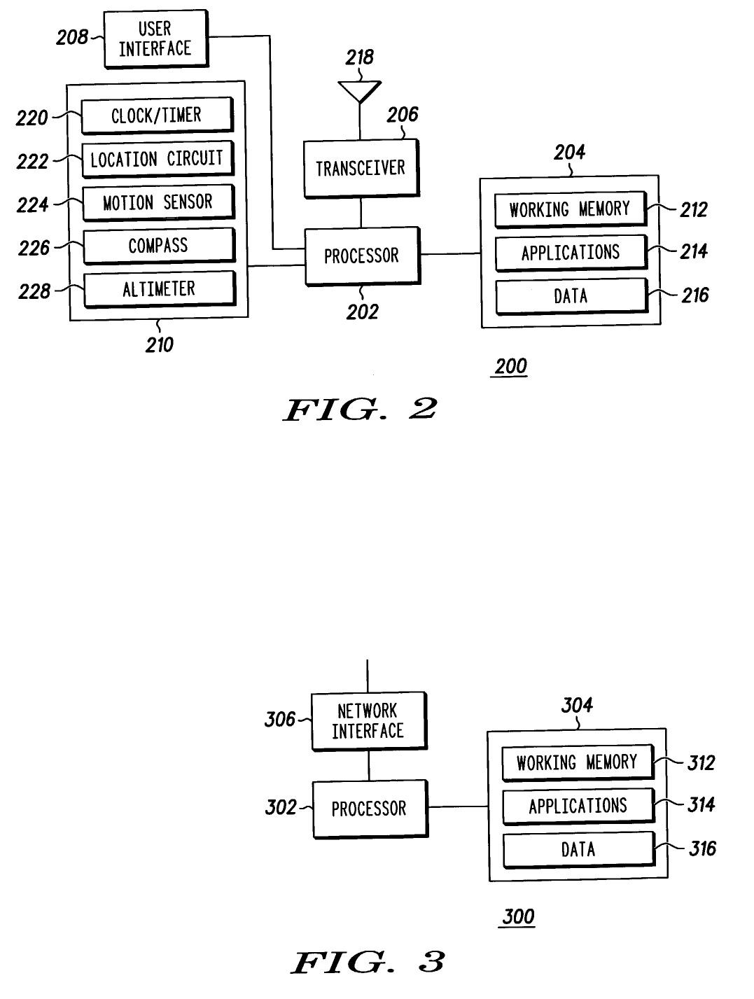

Referring to FIG. 2, the mobile stations 170 of the wireless communication system 100 include various internal components 200. Each mobile station 160, 162, 164, 166 includes a processor 202 and a memory 204, a transceiver 206, a user interface 208, and a sensor 210 that are coupled together for operation of the respective mobile station. It is to be understood that two or more of these internal components 200 may be integrated within a single package, or functions of each internal component may be distributed among multiple packages, without adversely affecting the operation of each mobile station 160, 162, 164, 166.

As stated above, each mobile station 160, 162, 164, 166 includes the processor 202 and the memory 204. The processor 202 controls the general operation of the mobile station 160, 162, 164, 166 including, but not limited to, processing and generating data for each of the other internal components 200. The memory 204 may include working memory portion 212, an application portion 214, and/or a data portion 216. The working memory portion 212 is utilized by the processor 202 for efficient manipulation of processed information. The application portion 214 includes operating instructions for the processor 202 to perform various functions of the mobile station 160, 162, 164, 166. A program of the set of the operating instructions may be embodied in a computer-readable medium such as, but not limited to, paper, a programmable gate array, flash memory, application specific integrated circuit (“ASIC”), erasable programmable read only memory (“EPROM”), read only memory (“ROM”), random access memory (“RAM”), magnetic media, and optical media. The data portion 216 stores data that is utilized by the applications stored in the application portion 214. For the preferred embodiment, the applications portion 214 is non-volatile memory that includes a client application for communicating with a main application operated at a remote device, and the data portion 216 is also non-volatile memory that stores data in a database that is utilized by the client application and associated with the mobile station 160, 162, 164, 166 or user of the mobile station.

As stated above, each mobile station 160, 162, 164, 166 also includes the transceiver 206 and the user interface 208. The transceiver 206 provides wireless communication capabilities with other entities, such as the communication network 110 and/or the mobile stations 170. For the preferred embodiment, the transceiver 206 operates through an antenna 218 in accordance with at least one of several standards including analog, digital or dual-mode communication system protocols and, thus, communicates with appropriate infrastructure, such as BSC's 120 and 125. However, as referenced above, the transceiver 206 may also provided point-to-point communication via an ad hoc network. The user interface may include a visual interface, an audio interface and/or a mechanical interface (not shown). Examples of the visual interface include displays and cameras, examples of the audio interface include speakers and microphones, and examples of the mechanical interface includes keypads, touch pads, selection buttons, vibrating mechanisms, and contact sensors.

As stated above, each mobile station 160, 162, 164, 166 further includes the sensor 210. The sensor 210 detects one or more events of its corresponding mobile station 160, 162, 164, 166 without necessitating user intervention. For the preferred embodiment, each mobile station 160, 162, 164, 166 includes one or more of the following sensors: the user interface 208, a clock/timer 220, a location circuit 222, a motion sensor 224, a compass 226 and an altimeter 228. The user interface 208 may detect user operation of the mobile station 160, 162, 164, 166. The clock/timer 220 may detect or track a current time of the mobile station 160, 162, 164, 166, and detect or tracks an elapsed time in relation to a given time. The location circuit 222 detects a location of the mobile station based on internal circuitry, via an external source, or both. Examples of the location circuit 222 include, but are not limited to, a global positioning system (GPS), a beacon system, and a forward link trilateration (FLT) system. The motion sensor 224 detects a velocity of the mobile station 160, 162, 164, 166 as it transgresses from one point to another point. The motion sensor 224 may work in conjunction with, or in place of, the clock/timer 220 and the location circuit 222. Examples of the motion sensor 224 include, but are not limited to, an accelerometer, a gyroscope, and a combination of a timing circuit and a location circuit. The compass 226 detects a direction of travel by the mobile station 160, 162, 164, 166, and the altimeter 228 detects an altitude of the mobile station. Although the compass 226 and/or altimeter 228 may be components that are built-in to the mobile station 160, 162, 164, 166, direction and altitude information may also be retrieved from a location circuit, such as a GPS.

Referring to FIG. 3, the server 180 of the communication network 110 includes various internal components 300. It is to be understood that mobile stations 170 may communicate with each other directly or through the communication network 110 without accessing the server 180 and, thus, the server is not required for proper operation in accordance with the present invention. For example, each mobile station 160, 162, 164, 166 may communication with a main application located at another mobile station instead of an application located at the server 180. The server 180 includes a processor 302 and a memory 304, and a network interface that are coupled together for operation of the server. It is to be understood that two or more of these internal components 300 may be integrated within a single package, or functions of each internal component may be distributed among multiple packages, without adversely affecting the operation of the server 180.

As stated above, the server 180 includes the processor 302 and the memory 304 and operates similarly to the processor 202 and the memory 204 of each mobile station 160, 162, 164, 166. The processor 302 controls the general operation of the server 180 including, but not limited to, processing and generating data for each of the other internal components 300. A program of the set of the operating instructions may,be embodied in a computer-readable medium such as, but not limited to, paper, a programmable gate array, flash memory, ASIC, EPROM, ROM, RAM, magnetic media, and optical media. The memory 304 may include working memory portion 312, an application portion 314, and/or a data portion 316. The working memory portion 312 is utilized by the processor 302 for efficient manipulation of processed information. The application portion 314 includes operating instructions for the processor 302 to perform various functions of the server 180. The data portion 316 stores data that is utilized by the applications stored in the application portion 314. For example, the applications portion 214 is non-volatile memory that may include a main application for communicating with a client application operated at one or more mobile stations 170, and the data portion 216 is also non-volatile memory that stores data utilized by the main application and associated with the mobile stations, the users of the mobile stations, and/or the server 180.

The server 180 may be operatively coupled to a database within the data portion 316 and integrated into the communication network 110. The server 180 may operate as a central server from the communication network 110 to provide the main application as described herein. Alternatively, the main application may be mobile station-centric such that the controller 210 may be integrated into at least one of the plurality of mobile stations 170 (one shown as 160 in FIG. 3). That is, one of the mobile stations 170 may act as a host mobile station or all of plurality of mobile stations 170 may act in conjunction with each other to operate the main application as described herein. In either case, each mobile station 160, 162, 164, 166 that does not include the main application would have a client application that communicates with the main application. If a mobile station 160, 162, 164, 166 includes the main application, that particular mobile station may or may not include a client application.

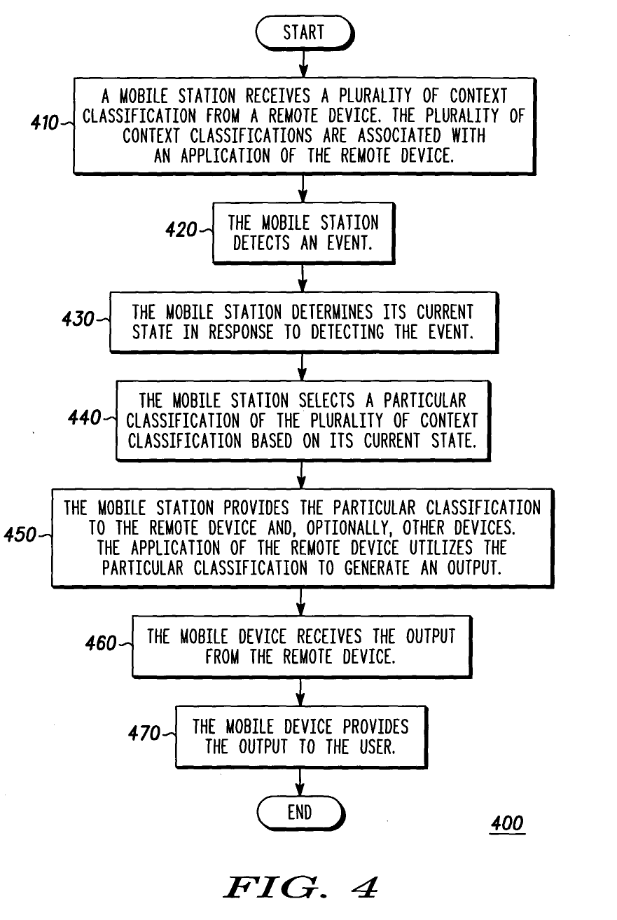

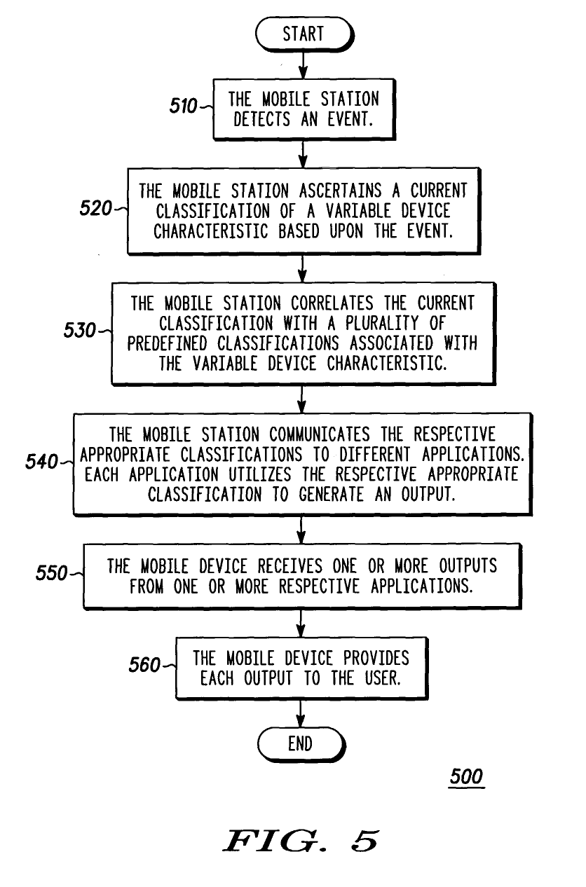

FIGS. 4 and 5 provide a preferred operation of one or more mobile stations 160, 162, 164, 166 of the wireless communication system 100. The mobile station 160, 162, 164, 166 correlates a current state of the mobile station to a particular classification desired by the main application, which is located at a remote device. In a first preferred embodiment, the remote device may be another mobile station 160, 162, 164, 166 or the server 180 located in the communication network 110. In a second preferred embodiment, the mobile station 160, 162, 164, 166 provides information to two different applications, which may reside at mobile stations, at servers, or at least one mobile station an at least one server. For both preferred embodiments, the processor 202 or an equivalent circuit performs the steps shown in conjunction with the other internal components 200 of the mobile station 160, 162, 164, 166.

Referring specifically to the first preferred embodiment represented by FIG. 4, in conjunction with FIG. 2, the mobile station 160, 162, 164, 166 receives two or more context classifications associated with a main application from a remote device at step 410. Preferably, the context classifications are received via a wireless communication link from the remote device, and the context classifications are one or more of the following types: user classes, a device types and an application types. The user classes identify a family relationship, a work relation and/or an application relationship of the mobile station relative to another entity, the device types identify functional capabilities of the mobile station and/or another entity, and the application types identify the application either an entertainment application or a security application. For user classes and device type, the other entity may be another mobile station 160, 162, 164, 166 or a virtual entity managed by the server 180.

The mobile station 160, 162, 164, 166 then detects an event of the mobile station at step 420. For example, the mobile station 160, 162, 164, 166 may detect a change of state of the mobile station. Next, the mobile station 160, 162, 164, 166 determines, in response to detecting the event, a current state of the mobile station at step 430. For example, the mobile station may determine the current state in terms of at least one of user operation, time, temperature, location, velocity, direction and altitude. The mobile station 160, 162, 164, 166 then selects a particular classification of the context classifications based on the current state of the mobile station at step 440. Thereafter, the mobile station 160, 162, 164, 166 provides the particular classification to the remote device for utilization by the application at step 450. Preferably, the particular classification is provided to the remote device via a wireless communication link.

In addition, the mobile station 160, 162, 164, 166 may manage information in a variety of ways. For example, the current state of the mobile station 160, 162, 164, 166 may also be provided with the particular classification to the remote device for utilization by the application. The current state may be shared with others via a peer-to-peer network or the communication network 110. Also, mobile station 160, 162, 164, 166 may collect supplemental information from one or more other mobile station via a peer-to-peer network or the communication network 110, combine the supplemental information with the particular classification, and provide the combined supplemental information and the particular classification to the remote device for utilization by the application. In addition, the mobile station 160, 162, 164, 166 may attach the current state and/or the particular classification to another application. A current state and/or a particular classification may be attached to other applications, such as a message to a friend or acquaintance. Further, the mobile station 160, 162, 164, 166 may combine a state with another state, a classification with another classification, or a state with a classification. Thus, classifications may be combined to create new classifications. For example, location information may be combined with a restaurant logo and, then, transmitted, shared or used in by an application.

In certain circumstances, the remote device may provide feedback to the mobile station 160, 162, 164, 166 in response to being provided the particular classification. In particular, after the remote device has utilized the particular classification to generate an output, the mobile station 160, 162, 164, 166 may receive the output from the remote device that the application has generated based on the particular classification via the transceiver 206 at step 460. If so, then the mobile station 160, 162, 164, 166 may provide the output to an output component of the mobile station, such as the user interface 208, at step 470.

Referring specifically to the second preferred embodiment represented by FIG. 5, in conjunction with FIG. 2, the mobile station 160, 162, 164, 166 detects an event of the mobile station at step 510. Preferably, the mobile station 160, 162, 164, 166 detects the event in terms of at least one user operation, time, temperature, location, velocity, direction and altitude. The mobile station 160, 162, 164, 166 then ascertains a current classification of a variable device characteristic based upon the event at step 520. In ascertaining the current classification, the mobile station 160, 162, 164, 166 identifies the variable device characteristic in terms of user classes, device types and application types. The user classes identify a family relationship, a work relation and/or an application relationship of the mobile station relative to another entity, the device types identify functional capabilities of the mobile station and/or another entity, and the application types identify the application either an entertainment application or a security application. For user classes and device type, the other entity may be another mobile station 160, 162, 164, 166 or a virtual entity managed by the server 180.

Next, the mobile station 160, 162, 164, 166 correlates the current classification with a plurality of predefined classifications associated with the variable device characteristic at step 530. The mobile station 160, 162, 164, 166 may have previously received the plurality of predefined classifications associated with a variable device characteristic from a remote device or the plurality of predefined classification may have been stored in the memory 204. Thereafter, the mobile station 160, 162, 164, 166 communicates the respective appropriate classifications to different applications at step 540. The mobile station 160, 162, 164, 166 may communicates with applications associated with the same or different variable device characteristic, and the communication is preferably via wireless communication link. Also, the different applications may reside with different remote devices.

Similar to the first preferred embodiment, the mobile station 160, 162, 164, 166 may manage information in a variety of ways. The current classification may also be communicated with the respective appropriate classifications to the different applications or, otherwise, shared with others. The mobile station 160, 162, 164, 166 may attach the current state and/or the particular classification to another application, such as a message to a friend or acquaintance. The mobile station 160, 162, 164, 166 may combine a state with another state, a classification with another classification, or a state with a classification and, thus, create a new classification.

Also, similar to the first preferred embodiment, the remote device, in certain circumstances, may provide feedback to the mobile station 160, 162, 164, 166 in response to being provided the particular classification. In particular, after the remote device has utilized the particular classification to generate an output, the mobile station 160, 162, 164, 166 may receive one or more outputs from one or more respective applications via the transceiver 206 at step 550. If so, then the mobile station 160, 162, 164, 166 may provide each output to an output component of the mobile station, such as the user interface 208, at step 560.

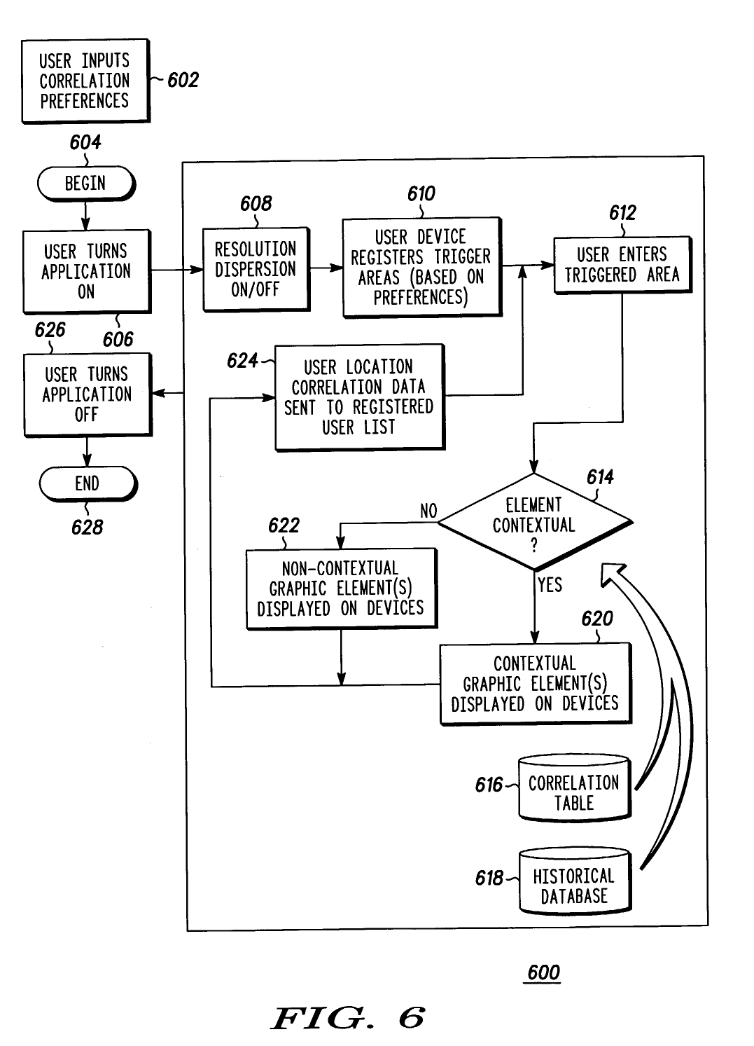

Referring to FIG. 6, there is shown a flow diagram illustrating a third preferred operation of the mobile station 160, 162, 164, 166. For the third embodiment, the mobile station 160, 162, 164, 166 determines the type of graphical elements that should be displayed to the user based on contextual information. First, before the general steps of correlating information, correlation preferences must be established at step 602. Preferably, the correlation preferences are established in advance by a user of the mobile station 160, 162, 164, 166. Some time thereafter, the correlation procedure begins when the mobile station 160, 162, 164, 166 calls-up the application at step 604. The application is then activated, preferably by the user, at step 606. Next, the mobile station 160, 162, 164, 166 detects when a resolution dispersion feature of the application is activated by the user at step 608. If the resolution dispersion feature is activated, then a broader scope of current statuses or triggering events will correlate with certain classifications. The mobile station 160, 162, 164, 166 also registers trigger areas, based on correlation preferences provided at step 602, with a registered user list at step 610. The registered user list may be located at a mobile station 160, 162, 164, 166 or the server 180, if available.

After initial steps 604 through 610, the mobile station 160, 162, 164, 166 is ready the general steps for correlating information. In particular, the mobile station 160, 162, 164, 166 detects whether it has entered a triggered area at step 612. After entering a triggered area, the mobile station 160, 162, 164, 166 determines whether a contextual element, such as user operation, time, temperature, location, velocity, direction and altitude, is associated with the triggering event at step 614. The mobile station 160, 162, 164, 166 makes this determination based on data stored in its memory 204, such as a correlation table 616 and a historical database 618. If a contextual element is associated with the triggering event, then the appropriate contextual graphic element is sent to an output device of the remote device at step 620. If a contextual element is not associated with the triggering event, then the appropriate non-contextual graphic element is sent to the output device of the remote device at step 622. The user location correlation data is then sent to the registered user list as step 624.

Steps 612 through 624 repeat themselves until the application is inactivated, by the user or the application, at step 626. Finally, the mobile station 160, 162, 164, 166 releases the application at step 628. For future usage, the correlation preferences may be established again at step 602, or reuse the current correlation preferences and calls-up the application at step 604.

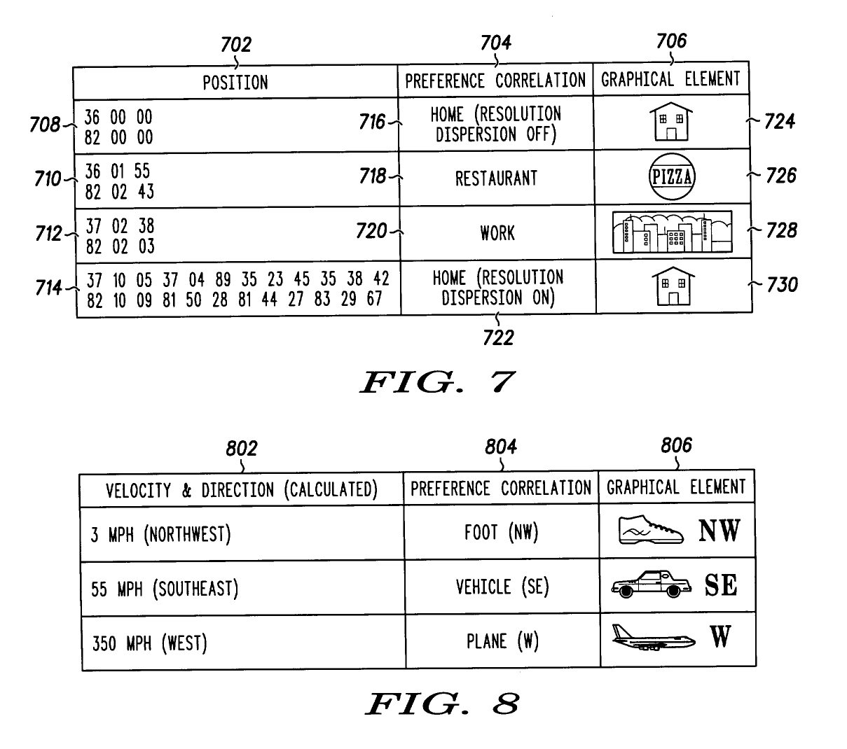

FIGS. 7 and 8 describe tables that represent exemplary information that is correlated by the wireless communication system 100. In particular, local information is correlated to predetermined categories of one or more remote entities. For a security application, specific information about a mobile station may be correlated to abstract information about the mobile station that is provided to the remote entity. For example, specific coordinates of the mobile station's location may be provided to the remote entity in the form of a less-clearly defined location of the mobile station, such as a city where the mobile station is located or a building generally located within a vicinity of the mobile station. For a gaming application, real information about a mobile station may be correlated to virtual information about a virtual entity of the game. For example, real movement of the mobile station from one real location to another real location may cause a virtual entity of the game to move from virtual location to another virtual location. For multiple applications, correlated information based on the same triggering event of the mobile station may be provided to each application. For example, an automatic or manual journal entry at the mobile station may trigger correlated information to be sent to two different applications. The correlated information may be the same or different, depending upon the type of information that the receiving entity should know or needs to know about the mobile station.

Referring to FIG. 7, there is provided a first table 700 representing exemplary information that is correlated by the wireless communication system 100. This first table 700 correlates position data 702, i.e., location information, with preference correlation data 704 and graphical elements 706. By example, the first table 700 provides several different position data 708, 710, 712, 714 that may be correlated to preference correlation data 704 and/or graphical elements 706. The position data 702 may be provided by a location circuit, such as the location circuit 222 of the mobile station 160, 162, 164, 166, in the form of exact location coordinates. Each position data 708, 710, 712, 714 corresponds to respective preference correlation data 716, 718, 720, 722 and/or respective graphical elements 724, 726, 728, 730. The resolution dispersion feature of the application is active for the fourth position data 714, so it includes more location data than the first, second and third position data 708, 710, 712, in which the dispersion feature is inactive.

For the example shown in FIG. 7, various position data 702 of the mobile station 160, 162, 164, 166 correspond to preference correlation data 704 that include Home (Resolution Dispersion Off), Restaurant, Work, and Home (Resolution Dispersion On). The same position data 702 also corresponds to graphical elements 706 that include an image of a house, a restaurant logo, and an image of office buildings. When the mobile station 160, 162, 164, 166 enters a triggered area matching one of the position data 702, then the mobile station may send the corresponding preference correlation data 704 and/or graphical element 706 to the remote device. For a gaming application, the preference correlation data 704 and/or graphical element 706 may be used to determine an action of a virtual entity of the game. For a security application, the preference correlation data 704 and/or graphical element 706 would provide abstract information about the mobile station's location instead of its exact coordinates. Preferably, as shown in FIG. 7, the remote device may receive similar information when the resolution dispersion feature is on and off, so the resolution dispersion feature may provide the mobile station 160, 162, 164, 166 with an added layer of security.

Referring to FIG. 8, there is provided a second table 800 representing exemplary information that is correlated by the wireless communication system 100. This second table 800 correlates velocity/direction data 802 with preference correlation data 804 and graphical elements 806. The position data 802 may be provided by one or more circuits, such as the location circuit 222, the motion sensor 224 and/or the compass 226 of the mobile station 160, 162, 164, 166. For the example shown in FIG. 8, various velocity/direction data 802 of the mobile station 160, 162, 164, 166 correspond to preference correlation data 804 that include velocity data, namely foot travel, vehicle travel and air travel, as well as direction data, namely northwestern (“NW”), southeast (“SE”) and western (“W”) movements. The same velocity/direction data 802 also corresponds to graphical elements 806 that include an image of a shoe, an image of an automobile, and an image of an airplane as well as directional symbols similar to those used for the preference correlation 804, namely NW, SE and W. When the mobile station 160, 162, 164, 166 detects a triggering event, then the mobile station may send the corresponding preference correlation data 804 and/or graphical element 806 to the remote device. For a gaming application, the preference correlation data 804 and/or graphical element 806 may be used to determine an action of a virtual entity of the game. For a security application, the preference correlation data 804 and/or graphical element 806 would provide abstract information about the mobile station's mode of travel instead of its exact velocity. It should be noted that the information provided to the remote device may include non-correlated information as well as correlated information. For example, as shown in FIG. 8, the graphical elements 806 include correlated information, namely the images of the shoe, automobile and airplane, as well as non-correlated information, namely the directional information.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a mobile station in communication with a remote device, the method comprising the steps of:
receiving a plurality of context classifications associated with an application from a remote device;
detecting an event of the mobile station;
determining, in response to detecting the event, a current state of the mobile station;
selecting a particular classification of the plurality of context classifications based on the current state of the mobile station; and
providing the particular classification to the remote device for utilization by the application.

2. The method of claim 1, wherein:
receiving a plurality of context classifications associated with an application from a remote device includes receiving the plurality of context classifications via a wireless communication network; and
providing the particular classification to the remote device for utilization by the application includes providing the particular classification via the wireless communication network.

3. The method of claim 1, wherein detecting an event of the mobile station includes detecting a change of state of the mobile station.

4. The method of claim 1, wherein determining a current state of the mobile station includes determining the current state in terms of at least one of user operation, time, temperature, location, velocity, direction and altitude.

5. The method of claim 1, wherein receiving a plurality of context classifications associated with an application from a remote device includes receiving at least one of user classes, a device types and an application types.

6. The method of claim 1, wherein receiving a plurality of context classifications associated with an application from a remote device includes receiving user classes that identify one of family relations, work relations and application relations of the mobile station relative to another entity.

7. The method of claim 1, wherein receiving a plurality of context classifications associated with an application from a remote device includes receiving device types that identify functional capabilities of at least one of the mobile station and another entity.

8. The method of claim 1, wherein receiving a plurality of context classifications associated with an application from a remote device includes receiving application types that identify the application to be one of an entertainment application and a security application.

9. The method of claim 1, further comprising the steps of:
receiving an output from the remote device that the application has generated based on the particular classification; and
providing the output to an output component of the mobile device.

10. The method of claim 9, wherein providing the output to an output component of the mobile device includes providing the output to at least one of a visual output component and an audio output component of the mobile device.

11. The method of claim 1, wherein providing the particular classification to the remote device for utilization by the application comprises:
collecting supplemental information from at least one other mobile station;
combining the supplemental information with the particular classification; and
providing the combined supplemental information and the particular classification to the remote device for utilization by the application.

12. The method of claim 1, further comprising attaching at least one of the current state and the particular classification to another application before providing the particular classification to the remote device for utilization by the application.

13. The method of claim 1, further comprising combining the particular classification with another classification before providing the particular classification to the remote device for utilization by the application.

14. A method of operating a mobile station in communication with a remote device, the method comprising the steps of:
detecting an event of the mobile station;
ascertaining a current classification of a variable device characteristic based upon the event;
correlating the current classification with a plurality of predefined classifications associated with the variable device characteristic; and
communicating the respective appropriate classifications to different applications.

15. The method of claim 14, wherein communicating the respective appropriate classifications to different applications includes communicating with applications associated with different variable device characteristic.

16. The method of claim 14, further comprising the step of receiving the plurality of predefined classifications associated with a variable device characteristic from a remote device.

17. The method of claim 14, wherein communicating the respective appropriate classifications to different applications includes communicating with applications residing with different remote devices.

18. The method of claim 14, wherein communicating the respective appropriate classifications to different applications includes communicating with the different applications via a wireless communication network.

19. The method of claim 14, wherein detecting an event of the mobile station includes detecting the event in terms of at least one of user operation, time, temperature, location, velocity, direction and altitude.

20. The method of claim 14, wherein ascertaining a current classification of a variable device characteristic based upon the event includes identifying the variable device characteristic in terms of user classes, device types and application types.

21. The method of claim 14, wherein ascertaining a current classification of a variable device characteristic based upon the event includes ascertaining a user class that identifies at least one of a family relation, a work relation and an application relation of the mobile station relative to another entity.

22. The method of claim 14, wherein ascertaining a current classification of a variable device characteristic based upon the event includes ascertaining a device type that identifies a functional capability of one of the remote device and another entity.

23. The method of claim 14, wherein ascertaining a current classification of a variable device characteristic based upon the event includes ascertaining an application type that identifies at least one of the different applications to be one of an entertainment application and a security application.

24. The method of claim 14, wherein communicating the respective appropriate classifications to different applications comprises:
collecting supplemental information from at least one other mobile station;
combining the supplemental information with the respective appropriate classifications; and
communicating the combined supplemental information and the respective appropriate classifications to the different applications.

25. The method of claim 14, further comprising attaching at least one of the current classification and the particular classification to another application before communicating the respective appropriate classifications to different applications.

26. The method of claim 14, further comprising combining each of the respective appropriate classifications with another classification before communicating the respective appropriate classifications to different applications.

27. A mobile station in communication with a remote device comprising:
a transceiver configured to receive a plurality of context classifications associated with an application from the remote device;
a sensor configured to detect an event of the mobile station; and
a processor, coupled to the transceiver and responsive to detection of the event by the sensor, configured to determine a current state of the mobile station and select a particular classification of the plurality of context classifications based on the current state of the mobile station, wherein the transceiver circuit provides the particular classification to the remote device for utilization by the application.

28. The mobile station of claim 27, wherein the transceiver receives the plurality of context classifications via a wireless communication network, and provides the particular classification via the wireless communication network.

29. The mobile station of claim 27, wherein the sensor detects a change of state of the mobile station.

30. The mobile station of claim 27, wherein the current state is at least one of user operation, time, temperature, location, velocity, direction and altitude.

31. The mobile station of claim 27, wherein the context classifications are one of user classes, a device types and an application types.

32. The mobile station of claim 27, wherein the context classifications are user classes that identify one of family relations, work relations and application relations of the mobile station relative to another entity.

33. The mobile station of claim 27, wherein the context classifications are device types that identify functional capabilities of at least one of the mobile station and another entity.

34. The mobile station of claim 27, wherein the context classifications are application types that identify the application to be one of an entertainment application and a security application.

35. The mobile station of claim 27, further comprising an output component of the mobile device, coupled to at least one of the transceiver and the processor, configured to provide an output received by the transceiver from the remote device to a user associated with the mobile station, wherein the application generates the output based on the particular classification selected by the processor.

36. The mobile station of claim 35, wherein the output component is at least one of a visual output component and an audio output component of the mobile device.

37. The mobile station of claim 27, wherein:
the transceiver collects supplemental information from at least one other mobile station;
the processor combines the supplemental information with the particular classification; and
the transceiver provides the combined supplemental information and the particular classification to the remote device for utilization by the application.

38. The mobile station of claim 27, wherein the processor attaches at least one of the current state and the particular classification to another application.

39. The mobile station of claim 27, wherein the processor combines the particular classification with another classification
